(19) United States
(12) Patent Application Publication
(10) Pub. No.: US 2022/0134799 A1
(43) Pub. Date: May 5, 2022

(54) Flexible Paint Tray Assembly

(71) Applicant: Lucas M. Boese, Burnsville, MN (US)

(72) Inventor: Lucas M. Boese, Burnsville, MN (US)

(21) Appl. No.: 17/089,378

(22) Filed: Nov. 4, 2020

(51) Int. Cl. B44D 3/12

(52) U.S. Cl. CPC B44D 3/126

(57) ABSTRACT

A flexible paint tray assembly includes a housing that is comprised of a resiliently bendable and stretchable material. The housing comprises a bottom wall that has a top side and a bottom side. A perimeter wall is attached to and extends upwardly from the bottom wall. The perimeter wall includes a front wall, a rear wall, a first side wall and a second side wall. The perimeter wall has an upper edge. The bottom wall includes a front portion adjacent to the front wall and a rear portion to the rear wall. The front portion is angled downwardly from the front wall to the rear portion such that the rear portion defines a receiving pool. The bottom side of the front portion is angled upwardly from the bottom side of the rear portion. The bottom side of the rear portion is planar and lies in a horizontal plane.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to paint tray device and more particularly pertains to a new paint tray device for removing dried paint from a paint tray easily by warping its shape wherein the tray will return to its original shape after being warped.

### (2) Description of Related Art Including Information Disclosed Under 37 CFR 1.97 and 1.98

The prior art relates to paint tray devices that are used for holding paint such that the paint may be applied to paint rollers, paint brushes and the like.

### BRIEF SUMMARY OF THE INVENTION

An embodiment of the disclosure meets the needs presented above by generally comprising a housing that is comprised of a resiliently bendable and stretchable material. The resiliently flexible material is a silicon material. The housing comprises a bottom wall that has a top side and a bottom side. The bottom wall has a perimeter edge including a front edge, a rear edge, a first lateral edge and a second lateral edge. A perimeter wall is attached to and extends upwardly from the bottom wall. The perimeter wall is coextensive with the perimeter edge. The perimeter wall and the bottom wall form a unitary structure. The perimeter wall includes a front wall, a rear wall, a first side wall and a second side wall. The perimeter wall has an upper edge. The bottom wall includes a front portion adjacent to the front wall and a rear portion to the rear wall. The front portion is angled downwardly from the front wall to the rear portion such that the rear portion defines a receiving pool. The bottom side of the front portion is angled upwardly from the bottom side of the rear portion. The bottom side of the rear portion is planar and lies in a horizontal plane.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a flexible paint tray assembly according to an embodiment of the disclosure.

FIG. 2 is a bottom isometric view of an embodiment of the disclosure.

FIG. 3 is a side view of an embodiment of the disclosure.

FIG. 4 is a bottom view of an embodiment of the disclosure.

FIG. 5 is a top isometric view of an embodiment of the disclosure.

FIG. 6 is a bottom view of an embodiment of the disclosure.

FIG. 7 is an in-use top isometric view of an embodiment of the disclosure.

### DETAILED DESCRIPTION OF THE INVENTION

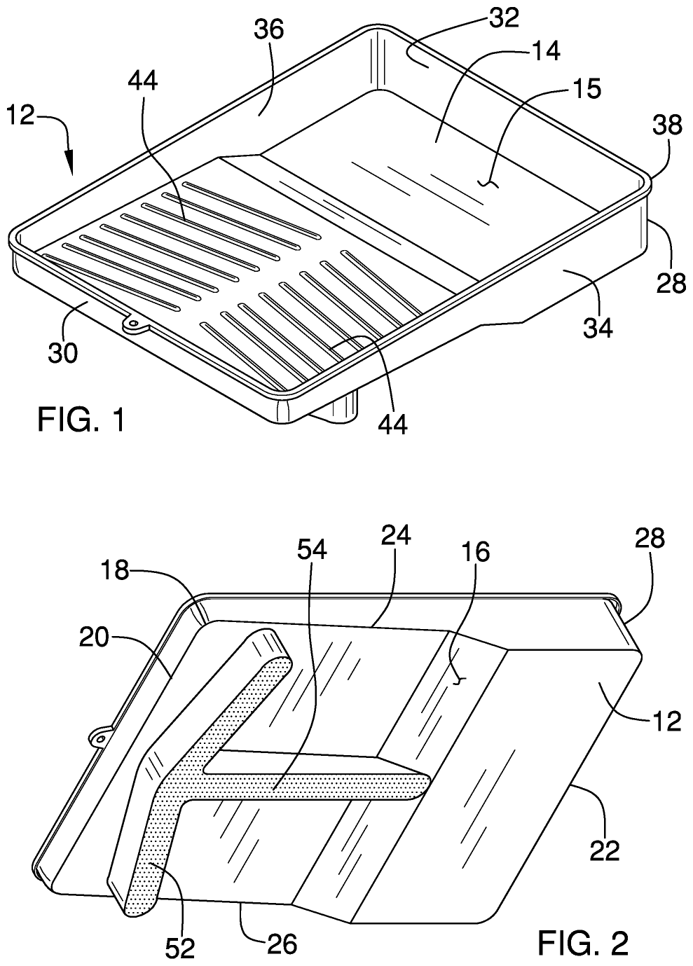

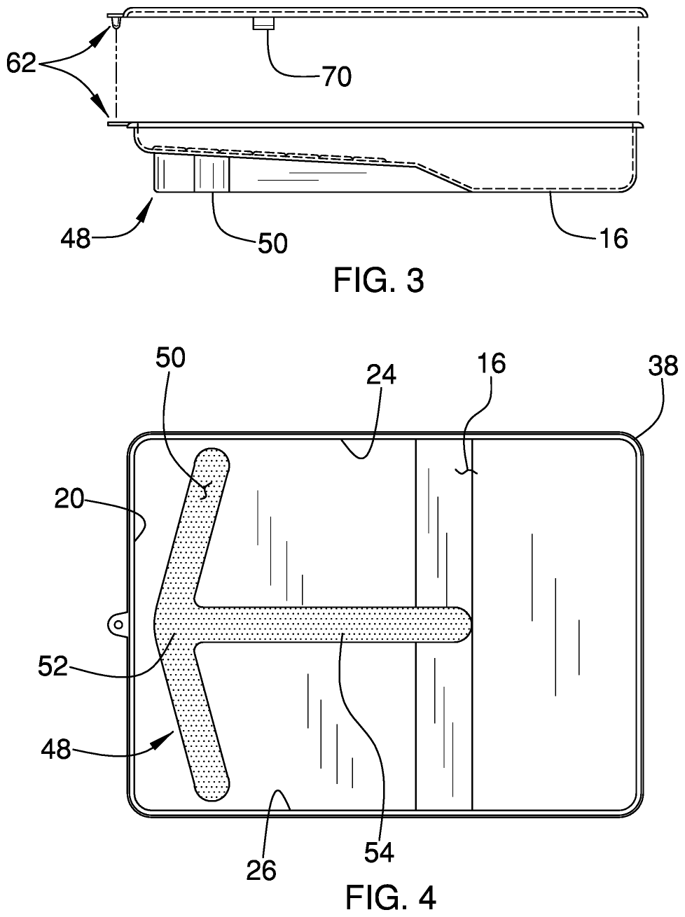

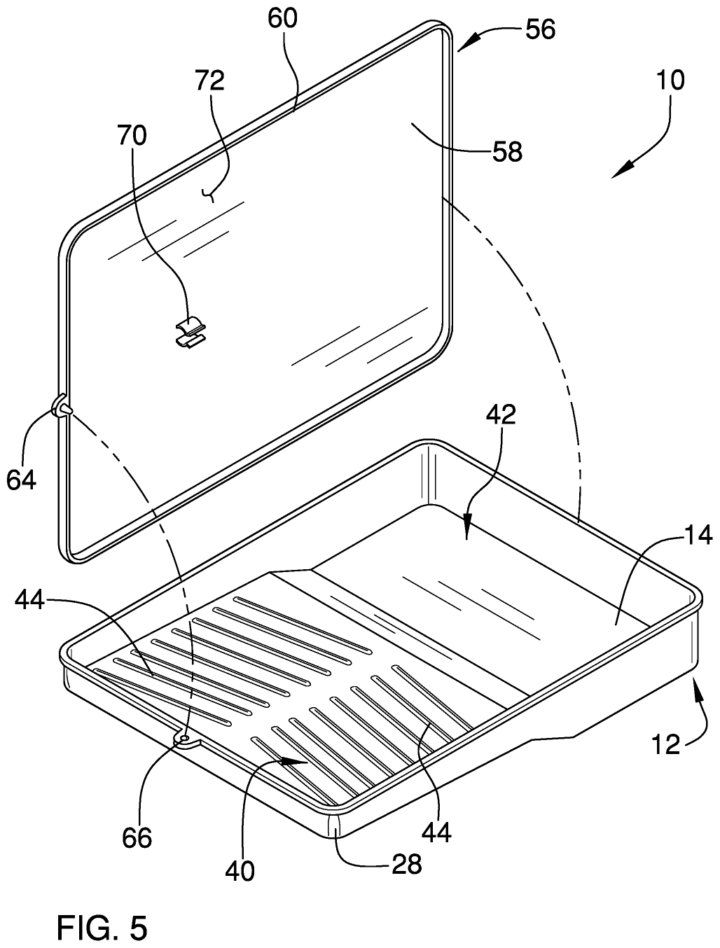

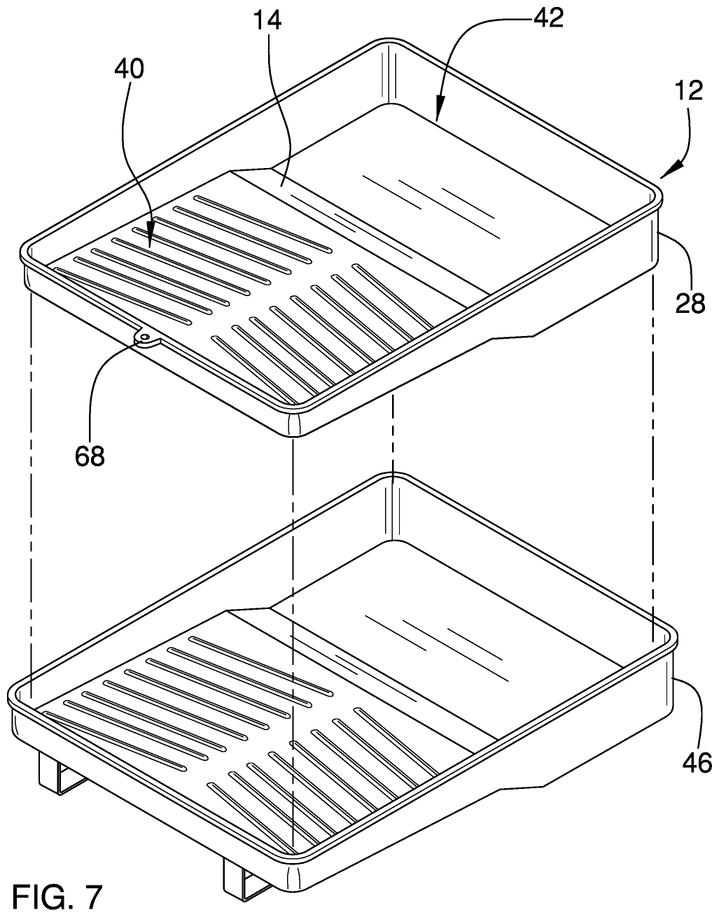

With reference now to the drawings, and in particular to FIGS. 1 through 7 thereof, a new paint tray device embodying the principles and concepts of an embodiment of the disclosure and generally designated by the reference numeral 10 will be described.

As best illustrated in FIGS. 1 through 7, the flexible paint tray assembly 10 generally comprises a housing 12 that is comprised of a resiliently bendable and stretchable material. While varying elastomers may be utilized, a silicon material may be preferably utilized. The silicon material preferably will have a structure that will allow the housing to hold a fluid, specifically paint, without bending too easily to prevent the fluid from easily spilling out of the housing. To that end, the silicon material will typically have the following parameters:

Hardness Shore A: 50±3

Tensile Strength MPa≥7.5

Elongation at Break %≥320

Permanent set at Break %≤8

Tear Strength Type B kN/m≥18

Density at 25° C.: 1.15±0.05 g/cm3

A bottom wall 14 of the housing 12 has a top side 15 and a bottom side 16. The bottom wall 14 has a perimeter edge 18 including a front edge 20, a rear edge 22, a first lateral edge 24 and a second lateral edge 26. A perimeter wall 28 is attached to and extends upwardly from the bottom wall 14. The perimeter wall 28 is coextensive with the perimeter edge 18 wherein the perimeter wall 28 and the bottom wall 14 form a unitary structure. The bottom 14 and perimeter 28 walls will typically have a thickness of greater than 0.05 inches and less than 0.25 inches. The housing 12 will have a size typical to a paint tray and therefore will have a width between 9.0 inches and 11.0 inches and a length between 12.0 inches and 18.0 inches. The housing 12 will have a greatest depth of between 3.0 inches and 5.0 inches. The perimeter wall 28 includes a front wall 30, a rear wall 32, a first side wall 34 and a second side wall 36. A perimeter shoulder 38 may be attached to and extend outwardly away from an upper edge of the perimeter wall 28 to provide more rigidity to the perimeter wall 38.

The bottom wall 14 includes a front portion 40 adjacent to the front wall 30 and a rear portion 42 to the rear wall 32. The front portion 40 is angled downwardly from the front wall 30 to the rear portion 42 such that the rear portion 42 defines a receiving pool and a depth of the housing 12 increases from the front wall 30 to the rear portion 42 to cause paint within the housing 12 to flow toward and pool into the rear portion 42. The bottom side 16 of the front portion 40 is angled upwardly from the bottom side 16 of the rear portion 42. The bottom side 16 of the rear portion 42 will typically be planar and lie in a horizontal plane, or will have an angle with respect to a horizontal plane being less than 3°. The top side 15 of the front portion 40 may include a plurality of protrusions 44 extending upwardly therefrom to frictionally engage a paint roller to cause the roller to rotate.

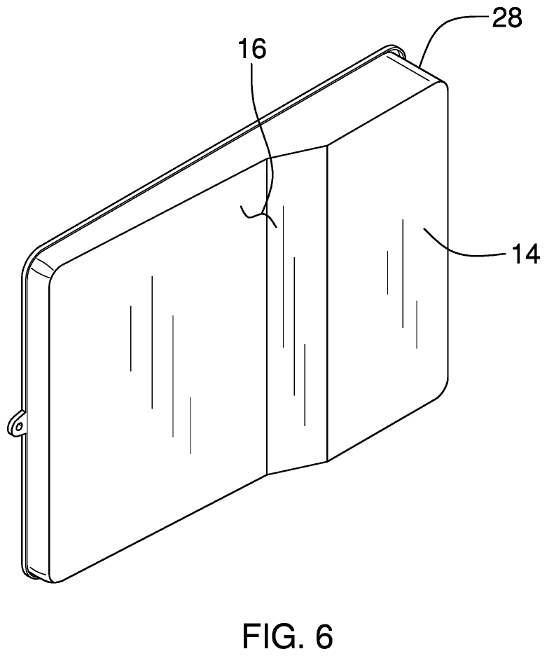

In embodiments found in FIGS. 5-7, the housing 12 may be used as a liner for a rigid plastic or metal paint tray 46. However, in another embodiment, a support 48 is attached to the bottom side 16 of the front portion 40. The support 48 forms a unitary structure with the bottom wall 14. The support 48 has a bottom surface 50 that is coplanar with the bottom side 16 of the rear portion 42. In one embodiment, the support 48 includes a front section 52 that is positioned adjacent to the front edge 20 and extends laterally toward the first 24 and second 26 lateral edges. The support 48 includes a central section 54 extending from the front section 52 to the bottom portion 42. The support 48, having the front 52 and central 54 sections, provides rigidity to the housing 12 along its longitudinal axis extending from the front edge 20 to the rear bottom portion 42 while still allowing the housing 12 to be twisted about its longitudinal axis.

A cover 56 is provided which may be comprised of a rigid or somewhat flexible material such as plastics, elastomers including rubbers and silicones, metals and the like. The cover 56 includes a top wall 58 having a downwardly extending perimeter lip 60 that is attached to and extends downwardly from the top wall 58. The perimeter lip 60 is extendable around and engageable with the perimeter wall 28 such that a substantially airtight seal is formed between the cover 56 and the perimeter wall 28 to prevent the drying out of paint located within the housing 12.

A coupler 62 releasably couples the cover 56 to the perimeter wall 28. The coupler 62 includes a first mating member 64 that is attached to the cover 56 and a second mating member 66 attached to the housing 12. The first 64 and second 66 mating members are removably engaged with each other when the cover 56 is positioned on and covers the housing 12. The second mating member 66 may form a uniform structure with the housing 12. The second mating member 66 may comprise a tab having an aperture 68 extending therethrough to allow the housing 12 to be hung on a fastener for storage or displaying purposes.

A receiver 70 may be attached to a lower surface 72 of the top wall 58. The receiver 70 is configured to releasably engage a paintbrush handle or the handle of a paint roller. This will allow the paintbrush to be sealed within the housing 12 and cover 56 to prevent the paint on the paintbrush from drying out. The receiver 70 may comprise, for example, one or more clips comprised of plastic or metallic materials.

In use, the housing 12 will be used as a conventional paint tray or a paint tray liner. The material and structure of the housing 12 will allow the housing 12 to hold a fluid without concern that the housing 12 will easily deform and spill the fluid. However, when a user is finished using the housing 12, the remaining paint will be allowed to dry and then the housing 12 twisted and/or turned inside out such that the paint will crack and fall away from the housing 12. After the paint has fallen away, the housing 12 is allowed to return to its regular shape. The interior of the housing 12 will have a smooth finish to prevent the paint from adhering to the housing 12 when it is dried. Additionally, the bottom side 16 of the housing 12 will comprise a non-slip surface to cause the housing 12 to not easily slide across a surface. The housing 12, including the second mating member 66, will typically be comprised of a single, uniform material which may be constructed in any conventional manner including, but not limited to, injection molding. This will ensure that the paint can be easily removed from the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flexible paint holding tray assembly comprising:
a housing being comprised of a resiliently bendable and stretchable material, the resiliently flexible material being a silicon material, the housing comprising:
a bottom wall having a top side and a bottom side, the bottom wall having a perimeter edge including a front edge, a rear edge, a first lateral edge and a second lateral edge;
a perimeter wall being attached to and extending upwardly from the bottom wall, the perimeter wall being coextensive with the perimeter edge, the perimeter wall and the bottom wall forming a unitary structure, the perimeter wall including a front wall, a rear wall, a first side wall and a second side wall, the perimeter wall having an upper edge; and
the bottom wall including a front portion adjacent to the front wall and a rear portion to the rear wall, the front portion being angled downwardly from the front wall to the rear portion such that the rear portion defines a receiving pool, the bottom side of the front portion being angled upwardly from the bottom side of the rear portion, the bottom side of the rear portion being planar and lying in a horizontal plane.

2. The flexible paint holding tray assembly according to claim 1, further including a perimeter shoulder being attached to and extending outwardly away from the upper edge.

3. The flexible paint holding tray assembly according to claim 1, wherein the top side of the front portion has a plurality of protrusions extending upwardly therefrom.

4. The flexible paint holding tray assembly according to claim 1, further including a support being attached to the bottom side of the front portion, the support forming a unitary structure with the bottom wall, the support having a bottom surface being coplanar with the bottom side of the rear portion.

5. The flexible paint holding tray assembly according to claim 4, wherein the support includes a front section being positioned adjacent to the front edge and extending laterally toward the first and second lateral edges.

6. The flexible paint holding tray assembly according to claim 5, wherein the support includes a central section extending from the front section to the bottom portion.

7. The flexible paint holding tray assembly according to claim 1, further including a cover, the cover including a top wall having a downwardly extending perimeter lip being attached to and extending downwardly from the top wall, the perimeter lip being extendable around and engageable with the perimeter wall.

8. The flexible paint holding tray assembly according to claim 7, further including a coupler releasably coupling the cover to the perimeter wall.

9. The flexible paint holding tray assembly according to claim 8, wherein the coupler includes a first mating member being attached to the cover and a second mating member being attached to the housing, the first and second mating members being removably engaged with each other when the cover is positioned on and covers the housing, the second mating member forming a uniform structure with the housing.

10. The flexible paint holding tray assembly according to claim 7, further including a receiver being attached to a lower surface of the top wall, the receiver being configured to releasably engage a paintbrush handle.

11. The flexible paint holding tray assembly according to claim 10, further including a support being attached to the bottom side of the front portion, the support forming a unitary structure with the bottom wall, the support having a bottom surface being coplanar with the bottom side of the rear portion.

12. The flexible paint holding tray assembly according to claim 11, wherein the support includes a front section being positioned adjacent to the front edge and extending laterally toward the first and second lateral edges.

13. The flexible paint holding tray assembly according to claim 12, wherein the support includes a central section extending from the front section to the bottom portion.

14. The flexible paint holding tray assembly according to claim 11, further including a coupler releasably coupling the cover to the perimeter wall.

15. A flexible paint holding tray assembly comprising:
a housing being comprised of a resiliently bendable and stretchable material, the resiliently flexible material being a silicon material, the housing comprising:
a bottom wall having a top side and a bottom side, the bottom wall having a perimeter edge including a front edge, a rear edge, a first lateral edge and a second lateral edge;
a perimeter wall being attached to and extending upwardly from the bottom wall, the perimeter wall being coextensive with the perimeter edge, the perimeter wall and the bottom wall forming a unitary structure, the perimeter wall including a front wall, a rear wall, a first side wall and a second side wall, the perimeter wall having an upper edge;
the bottom wall including a front portion adjacent to the front wall and a rear portion to the rear wall, the front portion being angled downwardly from the front wall to the rear portion such that the rear portion defines a receiving pool, the bottom side of the front portion being angled upwardly from the bottom side of the rear portion, the bottom side of the rear portion being planar and lying in a horizontal plane;
a perimeter shoulder being attached to and extending outwardly away from the upper edge;
the top side of the front portion having a plurality of protrusions extending upwardly therefrom;
a support being attached to the bottom side of the front portion, the support forming a unitary structure with the bottom wall, the support having a bottom surface being coplanar with the bottom side of the rear portion, the support including a front section being positioned adjacent to the front edge and extending laterally toward the first and second lateral edges, the support including a central section extending from the front section to the bottom portion;
a cover including a top wall having a downwardly extending perimeter lip being attached to and extending downwardly from the top wall, the perimeter lip being extendable around and engageable with the perimeter wall;
a coupler releasably coupling the cover to the perimeter wall, the coupler including a first mating member being attached to the cover and a second mating member being attached to the housing, the first and second mating members being removably engaged with each other when the cover is positioned on and covers the housing, the second mating member forming a uniform structure with the housing; and
a receiver being attached to a lower surface of the top wall, the receiver being configured to releasably engage a paintbrush handle.
